(19) United States
(12) Patent Application Publication
(10) Pub. No.: US 2019/0139152 A1
(43) Pub. Date: May 9, 2019

(54) INTELLIGENT PROCESS AND FRAMEWORK FOR BUILDING INDIVIDUAL LEGACY FOR PHILANTHROPIC IMPACT

(71) Applicant: Manju Makhanlal Seal, New York, NY (US)

(72) Inventor: Manju Makhanlal Seal, New York, NY (US)

(21) Appl. No.: 16/180,607

(22) Filed: Nov. 5, 2018

Related U.S. Application Data
(60) Provisional application No. 62/581,298, filed on Nov. 3, 2017.

(51) Int. Cl. G06Q 50/00

(52) U.S. Cl. CPC G06Q 50/01; G06F 17/12

(57) ABSTRACT

A method of building individual legacy for philanthropic impact includes a data processing system programmed to accept user input of user defined profiles; accept user input of at least one area of philanthropic interest; and accept user input of at least one choice of action to promote the area(s) of philanthropic interest. The system determines and identifies to the user potential entity choices that the user can consider philanthropically engaging with. At least one action plan for philanthropic activity for the potential entity choices is presented to the user. The user accepts at least one action plan for effecting philanthropic activity with the selected entity choice(s). Information reflecting philanthropic activity by the user is executed by the system and philanthropic activities by the user are tracked and the user is provided with progress of the user's philanthropic activity and impact of such activity.

### BACKGROUND OF THE INVENTION

### 1. Field of the Invention

The present invention generally relates to systems and methods for facilitating and managing philanthropic activities and, more specifically to an intelligent process and framework for building legacy for philanthropic impact by individuals or organizations.

### 2. Description of the Prior Art

The world is getting smaller each day with access to ever-burgeoning data, automated devices and applications, and increasing modes of connectivity. There are 83 million millennials in the USA and over a billion youth globally, often envision doing greater good in all aspects of living on this planet as agents of change. Corporations have Corporate Social Responsibility (CSR) and sustainability mandates. Family offices are keen to include impact investing in their portfolios, but there is not much thought given to guide individuals. A multi-pronged approach is required for applying all efforts/solutions available for tackling the wide range of social and environmental problems impacting people and the planet today (for example, the 17 Sustainable Development Goals (SDGs) set by the United Nations and beyond).

Increasingly, each person can choose to proactively think, design, and engage in building their own personal legacy for the greater good, benefiting people and the planet—locally and globally. We propose an intelligence-based framework utilizing big data, locational awareness and artificial intelligence that will enable us in bringing relevant, positive benefit locally and globally, demonstrating that people and their good intentions can be effective. It will empower an individual or a group of individuals or an organization to answer the question “What is my/our legacy? How do I design and execute my legacy-vision?” We need a single unified business process urgently for identifying, facilitating, building, executing and measuring one's own individual or organization's positive impact based on one's AOPI (Area(s) of Philanthropic Impact) benefitting people and the planet. The UN's' 17 sustainable development goals and its 169 targets are a good starting point to identify AOPI broadly or one can build their own AOPI as desired.

This business process aims to enable each individual or organization in designing their own “personal” legacy for greater good. It will provide an integrated solution to create a philanthropic portfolio built on personal choices of AOPI as an individual or group of individuals (e.g. a family or classroom) or an organization or a group of organizations, henceforth referred to as users. Integrating established portfolio management techniques and measurements (like total return) would widen the application to the private wealth management industry. Hence, both financial impact and philanthropic impact would be measured for one's AOPI portfolio.

This invention devises a workflow that will allow organizations or individuals to discover smart insights and philanthropic intelligence for executing meaningful positive actions for greater good anywhere. In addition, the workflow will allow each user—to apply locational awareness, identify AOPI to donate, locate experts or other related activities, to:
1. attribute customized actionable steps for the chosen AOPI, execute positive change, increase the circle of impact, network and influence, and finally, measure the positive impact.
2. allow each individual or organization to build their own eco-system for support, partnership by identifying applicable experts, and other organizations to work towards delivering a project while delivering positive impact for a given AOPI.
3. allow each individual or organization to self-register themselves, connect with others, and participate in discussion forums, if they choose to, and engage regarding their common AOPI.
4. enable local communities to self-prioritize their top challenges that need immediate focus, publish it for their communities and working groups, design an action plan, integrate the eco-system built in bullet 2, finally execute and track their impact and share (e.g. village or small locality).
5. Calculate impact for a given AOPI by attributing a monetized impact amount for each action performed (e.g. dollars donated or dollars invested or dollars in labor cost for total hours volunteered) to calculate a total monetized impact amount or a separate financial return using established portfolio management techniques wherever applicable.

In all of the cases above, locational awareness will enhance in cross-connecting individuals and organizations locally and globally. It will enable each individual and organization to work towards designing their own positive legacy by identifying AOPI, customizing steps for executing positive impact and measuring post-execution that positively impact people and the planet. Further, use of social media has a multiplier effect by driving additional impact, through peers being inspired by the legacy choices made by the individuals and following suit.

### SUMMARY OF THE INVENTION

Individuals and organizations are keen to support philanthropic and social AOPI meaningful to them. Given the proliferation of organizational entities, AOPI and related activities, and their highly dynamic nature, it is impossible for individuals to keep track of all options or build an action plan to systematically further their AOPI of interest easily. The invention uses a single unified framework based on artificial intelligence, data science and big data analytics to help individuals and organizations identify, facilitate, build, execute, and track their own individual or organizational positive impact to support one's AOPI.

Accordingly, a process framework is proposed based on artificial intelligence, big data analytics and linear programming approach to help individuals and organizations to identify the optimum entity and engagement choices to drive the highest legacy, given their location, areas of philanthropic interest, and actions of interest. While maximizing the individual/organizational legacy, the framework will also provide access to smaller, lesser-known entities to widen one's circle of influence. Quantifying one's individual or organizational legacy has a significant secondary benefit. When this information is shared on social media, it causes further effect by driving additional impact through the action choices made by the social network motivated by the post. This multiplier effect in today's world of social media can be transformative by engaging others for greater good.

To summarize, the uniqueness of innovation is multifold. The concept and the quantitative measurement of impact facilitates measurement, transparency, goal-setting and optimization towards the goals. AI techniques to ingest and codify unstructured information available about entity and engagement choices facilitate the creation of searchable structured data. Big data analytics applied to this data help individuals/organizations visualize choices of AOPI to optimize their portfolio. Lastly optimization formulation and solutions will maximize impact given the constraints of resources and goals. All these innovations together provide a single mechanism to help individuals and organizations drive maximum philanthropic impact, measure their impact, refine their actions and repeat.

### BRIEF DESCRIPTION OF THE DRAWINGS

Those skilled in the art will appreciate the improvements and advantages that derive from the present invention upon reading the following detailed description, claims, and drawings, in which:

FIG. 1 shows workflow of the intelligent framework;

FIG. 2 is a graph representation of potentially possible combinations;

FIG. 3 shows example data inputs for decision making;

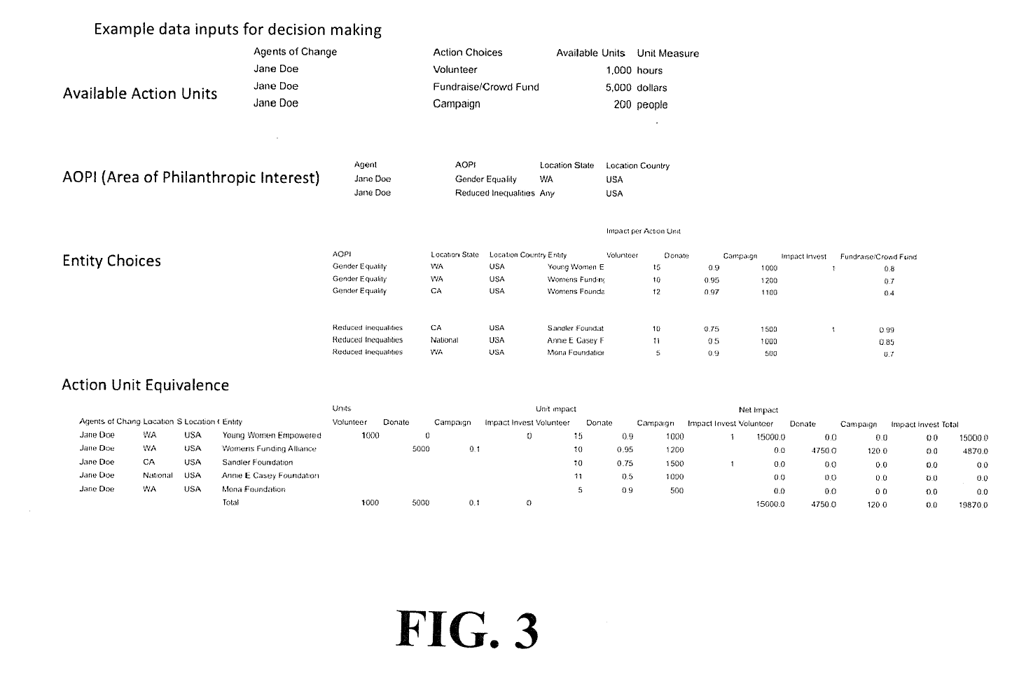

FIG. 4 shows sample wireframes to illustrate the concept and workflow; and

FIG. 5 shows sample wireframes to illustrate portfolio impact measurement and tracking.

### DESCRIPTION OF PREFERRED EMBODIMENT

Central to the approach is an intelligent workflow framework to match the profile of the individual to areas of philanthropic interest and actions to define and track a personal plan.

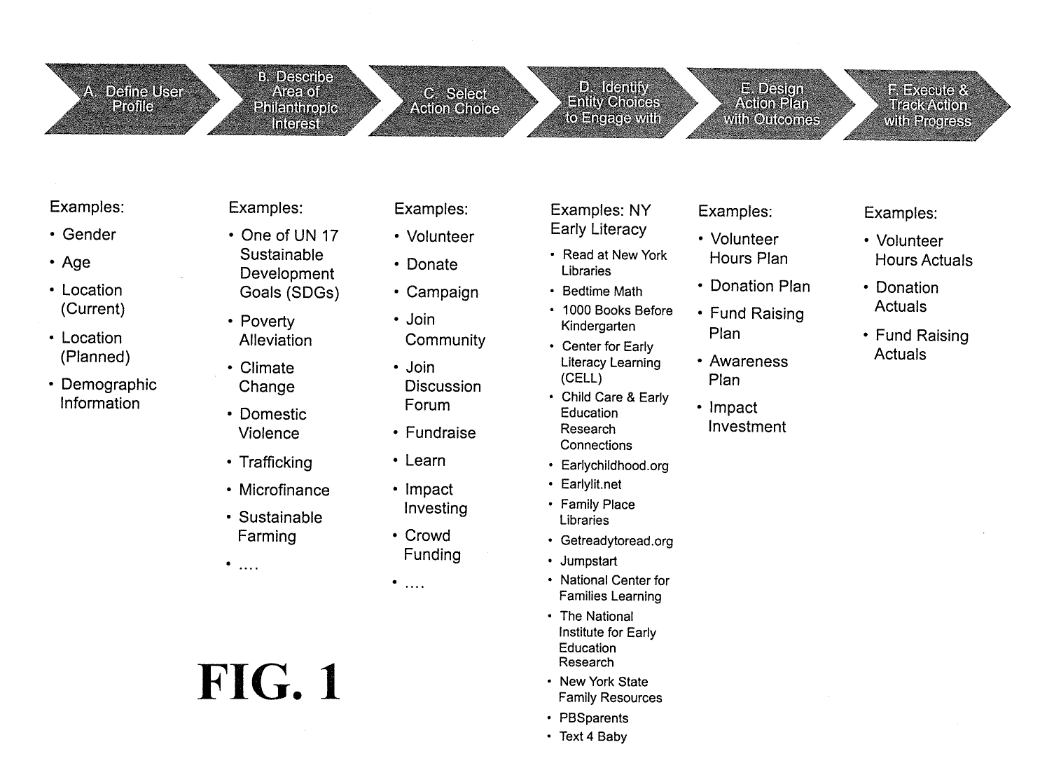

The overall workflow is described in FIG. 1. The method involves the following steps:

### A. Define Profile

In this step, the framework allows the user to specify as much or as little information about her using a user interface. Inputting more information will narrow the downstream choices to arrive at more targeted recommendations.

### B. Describe Area of Philanthropic Interest (AOPI)

In this step, the framework allows the user to specify information about her areas of philanthropic interest. Multiple (unrelated) areas can be selected at any level of drill-down that are broad or narrow topic, e.g. sustainable investing or early childhood education.

### C. Select Action Choice

In this step, the framework allows the user to specify single or multiple action choices.

### D. Identify Entity Choices

The algorithm determines the entity choices based on the profile data, AOPI and action choices. The entity choices are determined such that it maximizes the impact. This optimization is built on a linear programming formulation.

### E. Design Action Plan with Outcomes

The algorithm will assist the user in designing a suitable action plan, identifying desired outcomes.

### F. Execute Actions, Track Action with Progress

Depending on the actions recommended and selected by the user, the system executes the workflow as appropriate. If the user chooses to bucket a set of actions for an Area of Philanthropic Interest (for example, “Sanitation”), the system maintains separate portfolios for each of the Areas of Philanthropic Interest. If the user prefers to keep it separate, the following example, allows an action plan that consists of mixed Areas of Philanthropic Interest (Literacy and Domestic Violence). The workflow is demonstrated with the following example action plan.

For example, consider the following action plan is as follows:
1. Donate $150 to Bed Time Reading in January 2018
2. Impact Invest $5,000 with Acumen in December 2017
3. Volunteer 5 hours per week at Right Next Door from next week

In case 1, the system navigates to the Donate page of Bed Time Reading to prompt for donation collection. Depending on how the user profile is configured, it can potentially prepopulate the donation page with all the necessary information to allow the user to simply verify the details, make the payment and save the receipt

In the second or case 2 scenario, similarly, the system navigates to the Acumen page to facilitate the impact investment workflow.

In the third or case 3 scenario, the system navigates to the Right Next Door website and help the user sign up as a volunteer committing 5 hours.

In all the scenarios, the system allows user to log actions and activities to keep track of the activities as well as progress over time towards the goals set by the user initially. This can be shared over social media with as much or little transparency as desired.

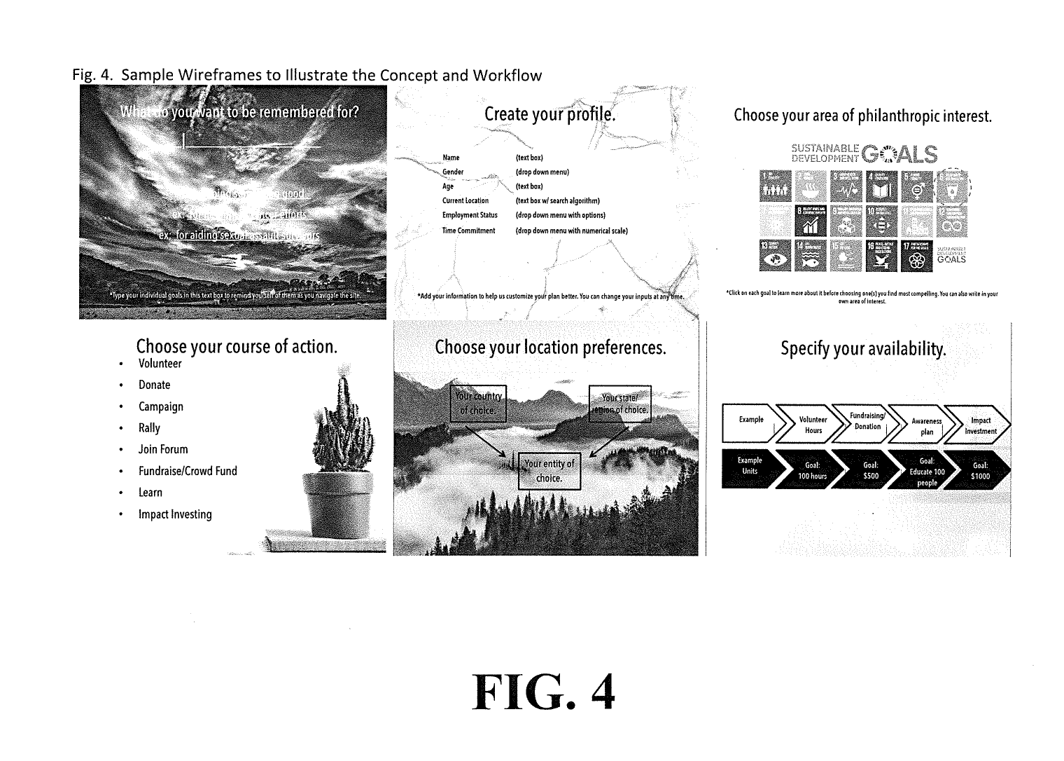

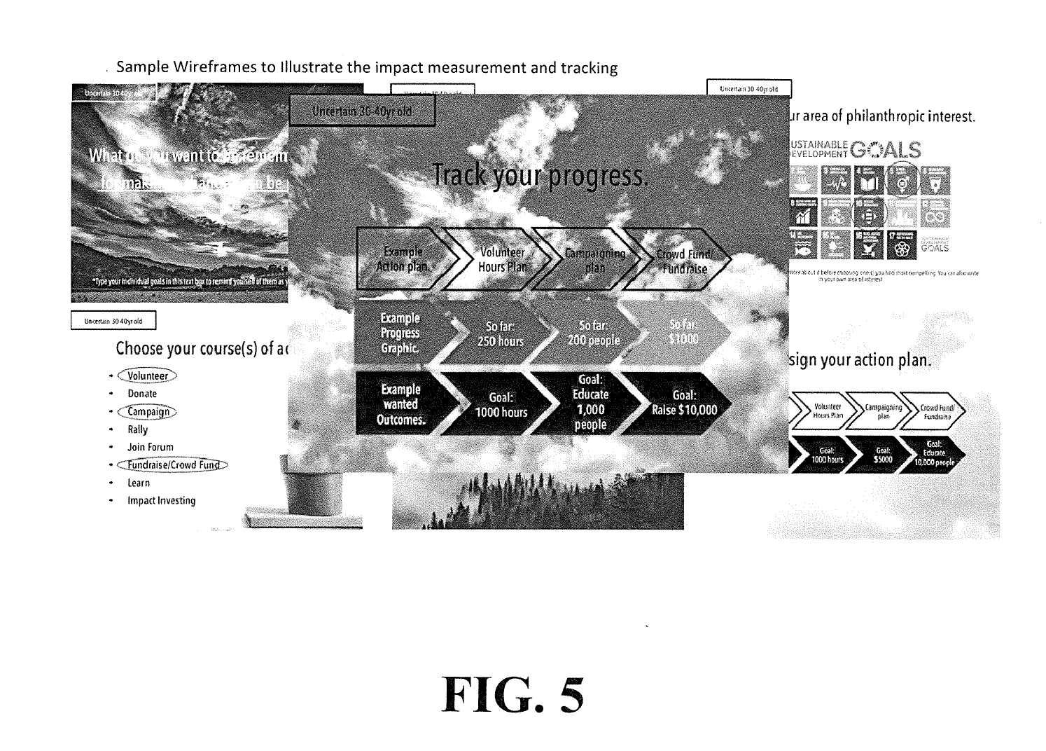

FIG. 4 displays the sample wireframes to further demonstrate the concept. Panels 1 and 2 demonstrate the individual creating his/her profile. Then they choose their AOPI, select the actions. FIG. 5 displays the wireframe to illustrate tracking of a portfolio of actions.

### Implementation Elements

### Intelligent Data Structure

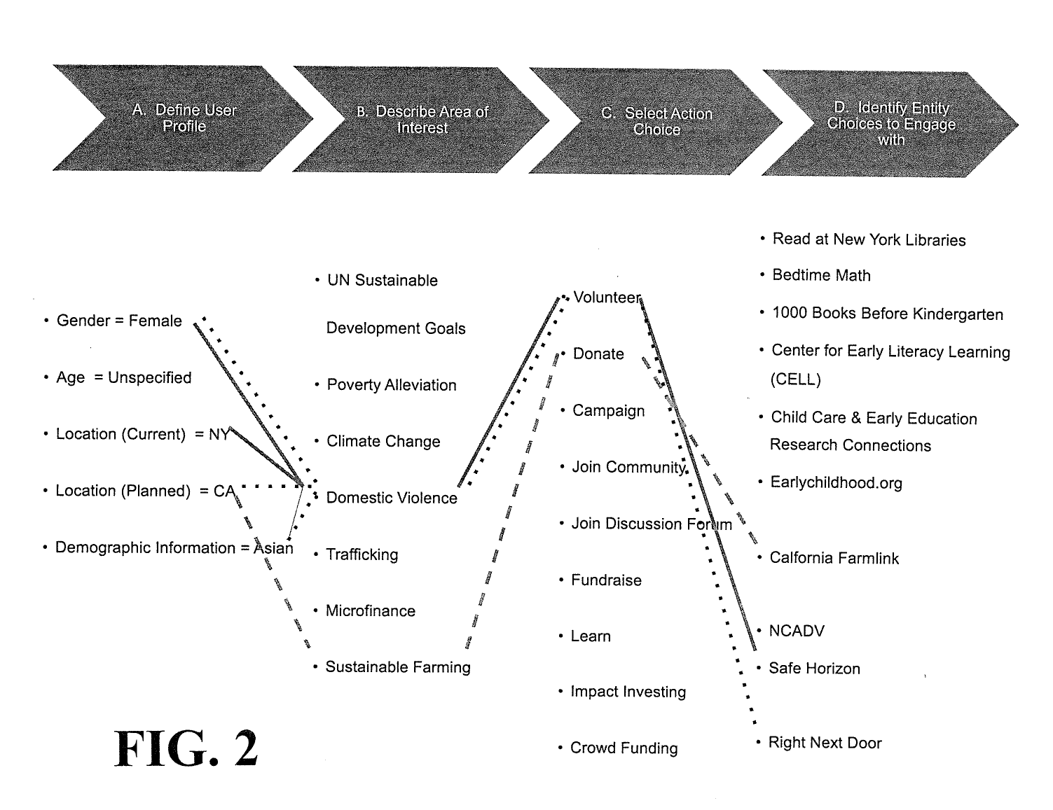

Based on the characteristics of the organization, only certain combinations of profile features, areas of philanthropic interest, action choices and organizations are feasible. We represent the feasible graphs as a sparse matrix representation. For example, the graphs that are feasible are shown in FIG. 2, and are represented as matrix of potentially possible combinations in Table 1.

TABLE 1

| | | Loca- | Loca- | | | |
|---|---|---|---|---|---|---|
| | | tion - | tion - | | | |
| Gender | Age | Current | Future | AOPI | Action | Organization |
| Female | — | NY | | Domestic | Volun- | Safe Horizon |
| | | | | Violence | teer | |
| Female | — | | CA | Domestic | Volun- | Right Next |
| | | | | Violence | teer | Door |
| — | — | CA | — | Sustainable | Donate | California |
| | | | | Farming | | FarmLink |

### Artificial Intelligence Application

The system has artificial intelligence capabilities to avoid manual selections in each of the steps. In Step A, the AI functionality can execute natural language processing to ingest the unstructured information from social media and other data sources such as LinkedIn, Facebook and Twitter to identify profile elements such as gender, age, and location (current and future).

Similarly, choices for areas of philanthropic interest, actions, and entities can be generated and dynamically refreshed using AI techniques including natural language processing (NLP) and machine learning. These AI techniques will populate various sets—the graph representation to be used in the user interface as well as the linear program.

### Impact Measurement

Measurement of one's impact is non-trivial to estimate. Let us take the example of someone interested in supporting victims of domestic violence. This person volunteers her time for a women's shelter. In addition, she also donates to NCADV, a leading grassroots organization with a voice on domestic violence. Lastly, she raises funds for SafeHorizon, an organization that empowers victims of domestic violence. She would be interested in quantifying her impact in this space, across all of these activities and actions. We propose an impact optimization algorithm to optimize the actions integrating multiple actions interacting with multiple entities.

Measuring impact and social return on investment has been widely studied and summarized in Table 2. For our approach, as an example, we incorporate the Impact Reporting & Investment Standards (IRIS) metrics, as they are easily monetizable. The monetization will help us cross compare the action choices at different entities and choose the set of activities that drive the maximum impact—comparing them on an even scale.

TABLE 2

| Name of | | | |
|---|---|---|---|
| Measurement | | | Organization |
| Tool | Aims to Measure | About | Behind it |
| IRIS | IRIS includes qualitative and quantitative metrics. | A set of standardized metrics for | Global Impact |
| | IRIS includes quantitative metrics that help you | describing social, environmental, | Investing |
| | measure multiple dimensions of your investees' | and financial performance of the | Network |
| | social, environmental, and financial performance. | organization. | (GIIN) |
| | IRIS also includes qualitative descriptors to help you | Basically, IRIS is designed to play | |
| | put your investees' performance in context. | the role in impact investing that | |
| | | Generally Accepted Accounting | |
| | | Principles (GAAP) or International | |
| | | Financial Reporting Standards | |
| | | (IFRS) bring to financial | |
| | | accounting. | |
| GIIRS | To obtain a third-party evaluation/judgment about a | A comprehensive rating of social | B Lab |
| | company or fund's performance | and environmental performance | |
| | To add credibility to fundraising processes and/or | | |
| | provide investors with guidance when making | | |
| | investment decisions | | |
| | To report to investors on the impact performance of a | | |
| | company, fund, or portfolio | | |
| | To identify areas of improvement for companies or | | |
| | funds to pursue to improve their social or | | |
| | environmental performance | | |
| Pulse | PULSE is designed to track financial, operational, | In a nutshell, PULSE helps | Acumen Fund |
| | social and environmental metrics, and features a | managers consolidate and centralize | |
| | range of qualitative reporting to complement | extensive data, making it easy to | |
| | quantitative performance management data. It | access, search and use. PULSE runs | |
| | creates and tracks customized metrics for individual | on the Salesforce platform and can | |
| | companies and qualitatively rates company | be integrated with an organization's | |
| | management using a standardized capabilities | customer relationship management | |
| | assessment of six areas: alignment with the investor's | (CRM) program and other front | |
| | mission, financial sustainability, potential for scale, | office solutions such as deal | |
| | potential for social impact, management capability, | tracking and pipeline management | |
| | and business model effectiveness. | software. | |
| Grantee | The GPR is based on a comprehensive survey of | The GPR is a management tool that | Center for |
| Perception | grantees covering issues such as interactions during | provides foundation CEOs, boards, | Effective |
| Report | the grant, the application and reporting processes, and | and staff with comparative data on | Philanthropy |
| (GPR) | perceived foundation impact. | grantee perceptions of their | |
| | | foundation's performance on a | |
| | | variety of dimensions. | |

### Linear Programming Formulation

To facilitate the optimization, we formulate the scenarios as linear mathematical program, which can be optimized or heuristically solved with a standard knapsack algorithm.

Using the impact metric from above, we can determine the impact provided by an action at an entity per unit of action—for example—the impact per hour of volunteering at Safe Horizon or impact per $ donated to California Farmlink. Given the constraint of action units available in each location, the algorithm selects the optimum distribution of these action units at each entity.

In Table 3 the “universe” refers to the subset of universal choices applicable to the user (individual or organization), meaning the universe for the user is CA and NY for location choices, versus all geographic locations.

TABLE 3

| Field | Notation | Example/Description |
|---|---|---|
| Profile field | i ϵ I - universe of profile field possibilities | Location ϵ {CA, NY} |
| AOPI | j ϵ J - universe of areas of interest | Interest ϵ {Sustainable Development Goals, |
| | | Poverty Alleviation, Climate Change, |
| | | Domestic Violence, Trafficking, |
| | | Microfinance, Sustainable Farming} |
| Action Choice | k ϵ K - universe of action c [symbol] oices | Action ϵ {Volunteer, Donate, Campaign, Join |
| | | Community, Join Discussion Forum, |
| | | Fundraise, Learn, Impact Investing} |
| Entity Choice | l ϵ L - universe of entity c [symbol] oices | Entity ϵ {Read at New York Libraries, |
| | | Bedtime Math, 1000 Books Before |
| | | Kindergarten, Center for Early Literacy, |
| | | Learning (CELL), Child Care & Early |
| | | Education Research Connections, |
| | | Earlychildhood.org, Earlylit.net, Family Place |
| | | Libraries, Getreadytoread.org, Jumpstart, |
| | | National Center for Families Learning, The |
| | | National Institute for Early Education |
| | | Research, New York State Family Resources, |
| | | PBSparents, Text 4 Baby} |
| Option Universe | Ωᵢⱼₖₗ i ϵ I, j ϵ J, k ϵ K, l ϵ L | Possible combinations of profile field values, |
| | | areas of philanthropic interest, action choices, |
| | | and entity choices |
| Available Action | Φᵢₖ i for location ϵ I, k ϵ K | {(CA, Volunteer = 15), (NY, Volunteer = 40), |
| Units | | (Any, Donate = $500), (Any, Impact Invest = |
| | | $10,000)} |
| Impact per Action | λᵢₖₗ i for location ϵ I, k ϵ K, l ϵ L | λ (NY, Volunteer, Read at NY Libraries) = |
| Unit | | $15/hour |
| | | λ (Any, Donate, Bedtime Math) = $0.9/$ |
| | | λ (Any, Invest, Acumen) = $1 |
| Recommended | μₖₗ k ϵ K, l ϵ L | {(Volunteer = 5, Read at NY Libraries), |
| Actions | | (Volunteer 35, Bedtime Math), |
| | | (Volunteer = 15, California Farmlink), |
| | | (Donate = $500, Right Next Door), (Impact |
| | | Invest = $10,000, Acumen)} |

Linear programming formulation is as follows:

$$Maximize {\sum }_{k ∈ K} {\sum }_{l ∈ L} {μ}_{kl} * {λ}_{ikl}$$

subject to

$${\sum }_{l ∈ L} {λ}_{ikl} \leq {Φ}_{ik} ∀ i for location ∈ I , k ∈ K , l ∈ L$$

This is a standard knapsack linear programming formulation and can be solved using traditional SIMPLEX algorithm for full optimization.

A process framework is, therefore, proposed based on artificial intelligence, big data analytics and linear programming approach to help individuals and organizations to identify the optimum entity and engagement choices to drive the highest legacy, given their location, areas of philanthropic interest, and actions of interest. While maximizing the individual/organizational legacy, the framework will also provide access for smaller, lesser-known entities and give maximum opportunity to drive legacy. Quantifying one's individual or organizational legacy has a significant secondary benefit. When this information is shared on social media, it causes further effect by driving additional impact through the action choices made by the social network motivated by the post. This multiplier effect in today's world of social media can be transformative by engaging others in driving philanthropic impact and widening the circle of impact influence for greater good.

1. A method of building individual legacy for philanthropic impact comprising the steps of programming a data processing system to perform the following functions: accepting user input of user defined profiles; accepting user input of at least one area of philanthropic interest; accepting user input, on the basis of said at least one area of philanthropic interest, of at least one choice of action to promote said at least one area of philanthropic interest; determining and identifying to the user, on the basis of said accepted user inputs, potential entity choices that the user can consider philanthropically engaging with; presenting at least one action plan for philanthropic activity for said potential entity choices; accepting at least one action plan entered by the user for effecting philanthropic activity with said selected entity choices; executing information reflecting philanthropic activity by the user; tracking philanthropic activities by the user; and providing user with progress of philanthropic activity and impact of such activity.

2. A method as defined in claim 1, wherein said user defined profiles include one or more of gender, age, current location, planned location and demographic information.

3. A method as defined in claim 1, wherein said areas of interest include one or more of One of UN 17 Sustainable Development Goals (SDGs), Poverty Alleviation, Climate Change, Domestic Violence, Trafficking, Microfinance, Sustainable Farming, Early Childhood Education, Sustainable Investing.

4. A method as defined in claim 1, wherein said action choices includes one or more of Volunteer, Donate, Campaign, Join Community, Join Discussion Forum, Fundraise, Learn, Impact Investing, Crowd Funding.

5. A method as defined in claim 1, wherein said entity choices for a user to engage with includes one or more of Read at Public Libraries, Bedtime Math, 1000 Books Before Kindergarten, Center for Early Literacy Learning (CELL), Child Care and Early Education Research Connections, Earlychildhood.org, Earlylit.net, Family Place Libraries, Getreadytoread.org, Jumpstart, National Center for Families Learning, The National Institute for Early Education Research, New York State Family Resources, PBSparents, Text 4 Baby.

6. A method as defined in claim 1, wherein said action plan includes one or more of Volunteer Hours Plan, Donation Plan, Fund Raising Plan, Awareness Plan, Impact Investment.

7. A method as defined in claim 1, wherein said processing system executes at least one or more of Volunteer Hours Actuals, Donation Actuals, Fund Raising Actuals.

8. A method as defined in claim 1, further comprising the step of posting at least one of said areas of philanthropic interest, action choices and entity choices to engage with on social media.

9. A method as defined in claim 1, wherein said programming of the data processing system includes use of a unified framework based on artificial intelligence (AI), data science and big data analytics.

10. A method as defined in claim 1, wherein said programming of the data processing system includes use of linear programming to identify optimum potential entity choices based on said user inputs.

11. A method as defined in claim 10, wherein said linear programming is as follows:
$$Maximize {\sum }_{k ∈ K} {\sum }_{l ∈ L} {μ}_{kl} * {λ}_{ikl}$$
subject to
$${\sum }_{l ∈ L} {λ}_{ikl} \leq {Φ}_{ik} ∀ i for location ∈ I , k ∈ K , l ∈ L$$
where

| Field | Notation | Example/Description |
|---|---|---|
| Profile field | i ϵ I - universe of profile field possibilities | Location ϵ {CA, NY) |
| AOPI | j ϵ J - universe of areas of interest | Interest ϵ {Sustainable Development Goals, |
| | | Poverty Alleviation, Climate Change, |
| | | Domestic Violence, Trafficking, |
| | | Microfinance, Sustainable Farming} |
| Action Choice | k ϵ K - universe of action c [symbol] oices | Action ϵ {Volunteer, Donate, Campaign, Join |
| | | Community, Join Discussion Forum, |
| | | Fundraise, Learn, Impact Investing} |
| Entity Choice | l ϵ L - universe of entity c [symbol] oices | Entity ϵ {Read at New York Libraries, |
| | | Bedtime Math, 1000 Books Before |
| | | Kindergarten, Center for Early Literacy, |
| | | Learning (CELL), Child Care & Early |
| | | Education Research Connections, |
| | | Earlychildhood.org, Earlylit.net, Family Place |
| | | Libraries, Getreadytoread.org, Jumpstart, |
| | | National Center for Families Learning, The |
| | | National Institute for Early Education |
| | | Research, New York State Family Resources, |
| | | PBSparents, Text 4 Baby} |
| Option Universe | Ωᵢⱼₖₗ i ϵ I, j ϵ J, k ϵ K, l ϵ L | Possible combinations of profile field values, |
| | | areas of philanthropic interest, action choices, |
| | | and entity choices |
| Available Action | Φᵢₖ i for location ϵ I, k ϵ K | {(CA, Volunteer = 15), (NY, Volunteer = 40), |
| Units | | (Any, Donate = $500), (Any, Impact Invest = |
| | | $10.000)} |
| Impact per Action | λᵢₖₗ i for location ϵ I, k ϵ K, l ϵ L | λ (NY, Volunteer, Read at NY Libraries) = |
| Unit | | $15/hour |
| | | λ (Any, Donate, Bedtime Math) = $0.9/$ |
| | | λ (Any, Invest, Acumen) = $1 |
| Recommended | μₖₗ k ϵ K, l ϵ L | {(Volunteer = 5, Read at NY Libraries), |
| Actions | | (Volunteer 35, Bedtime Math), |
| | | (Volunteer = 15, California Farmlink), |
| | | (Donate = $500, Right Next Door), (Impact |
| | | Invest = $10.000, Acumen)} |

12. A method as defined in claim 1, wherein impact is measured by utilizing Impact Reporting and Investment Standards (IRIS) metrics.

13. A method as defined in claim 3, wherein said data processing system is programmed to be open-ended and accept additional areas of interest.

14. A method as defined in claim 4, wherein said data processing system is programmed to be open-ended and accept additional action choices.

15. A method as defined in claim 5, wherein said data processing system is programmed to be open-ended and accept additional entity choices.

16. A method as defined in claim 6, wherein said data processing system is programmed to be open-ended and accept additional action plans.

17. A method as defined in claim 6, wherein progress and tracked actions are conveyed to user.

18. A method of building individual legacy for philanthropic impact comprising the steps generating user input of user defined profiles; generating user input of at least one area of philanthropic interest; generating user input, on the basis of said at least one area of philanthropic interest, of at least one choice of action to promote said at least one area of philanthropic interest; determining and identifying to the user, on the basis of said accepted user inputs, potential entity choices that the user can consider philanthropically engaging with; presenting at least one action plan for philanthropic activity for said potential entity choices; accepting at least one action plan entered by the user for effecting philanthropic activity with said selected entity choices; executing information reflecting philanthropic activity by the user; tracking philanthropic activities by the user; and providing user with progress of philanthropic activity and impact of such activity.

19. A data processing system for building individual legacy for philanthropic impact comprising means for programming a data processing system to perform the following functions: means for accepting user input of user defined profiles; means for accepting user input of at least one area of philanthropic interest; means for accepting user input on the basis of said at least one area of philanthropic interest, of at least one choice of action to promote said at least one area of philanthropic interest; means for determining and identifying to the user, on the basis of said accepted user inputs, potential entity choices that the user can philanthropically engage with; means for presenting at least one action plan for philanthropic activity for said potential entity choices; means for accepting at least one action plan entered by the user for effecting philanthropic activity with said selected entity choices; executing information reflecting philanthropic activity; means for tracking philanthropic activities by the user; and means for providing a user with progress of philanthropic activity and impact of such activity.

20. A method as defined in claim 19, wherein said data processing system comprises a general purpose computer.
